(19) United States
(12) Patent Application Publication
(10) Pub. No.: US 2020/0388908 A1
(43) Pub. Date: Dec. 10, 2020

(54) ANTENNA APPARATUS

(71) Applicant: HARADA INDUSTRY CO., LTD., Tokyo (JP)

(72) Inventors: Conglin YANG, Tokyo (JP); Toshihiro IWATA, Tokyo (JP)

(21) Appl. No.: 16/547,980

(22) Filed: Aug. 22, 2019

(30) Foreign Application Priority Data
Jun. 5, 2019 (JP) 2019-105552

(51) Int. Cl. H01Q 1/32; H01Q 1/22

(52) U.S. Cl. CPC H01Q 1/3275; H01Q 1/22; H01Q 1/3208

(57) ABSTRACT

An antenna apparatus includes: a base member; a case member fixed to the base member with a fixing tool; and a pad member for covering a peripheral edge of the base member. The case member has a boss into which the fixing tool is inserted. A portion of the pad member is compressed by fixing the boss and the base member with the fixing tool.

### CROSS-REFERENCE TO RELATED APPLICATION

This application claims priority from Japanese Patent Application No. 2019-105552 filed with the Japan Patent Office on Jun. 5, 2019, the entire content of which is hereby incorporated by reference.

### BACKGROUND

### 1. Technical Field

Embodiments of the present disclosure relate to an on-vehicle antenna apparatus.

### 2. Related Art

Typically, as the antenna apparatus mounted on the vehicle or the like, the antenna apparatus mounted on a roof of the vehicle is known. Such an antenna apparatus has a structure in which a circuit board for communication is compactly housed in a closed space formed by a base member for arranging a circuit and a connector, and a case member covering the base member. A recent on-vehicle antenna apparatus is configured to receive signals in various frequency bands such as GNSS (Global Navigation Satellite System) signals and ETC (Electronic Toll Collection System) signals in addition to broadcast signals such as television signals and radio signals. Therefore, an amplifier circuit, a filter circuit, and the like corresponding to the signals in various frequency bands are provided on the circuit board.

As described above, a precision device such as a circuit board is disposed in the closed space formed by the base member and the case member. Therefore, in order to restrain moisture and dust from entering an inside space, the closed space is required to have good waterproofness and dustproofness. As a technique for ensuring waterproofness and dustproofness, for example as described in JP-A-2005-102031, a technique is known in which a lower surface portion and an outer peripheral portion of the base member are covered with a pad member made of an elastic material.

### SUMMARY

An antenna apparatus includes: a base member; a case member fixed to the base member with a fixing tool; and a pad member for covering a peripheral edge of the base member. The case member has a boss into which the fixing tool is inserted. A portion of the pad member is compressed by fixing the boss and the base member with the fixing tool.

### BRIEF DESCRIPTION OF THE DRAWINGS

FIG. 1 is a perspective view showing an appearance of an antenna apparatus of a first embodiment;

FIG. 2 is an exploded perspective view showing an internal structure of an antenna mounting unit in the antenna apparatus of the first embodiment;

FIGS. 3A and 3B are perspective views showing the internal structure of the antenna mounting unit in the antenna apparatus of the first embodiment;

FIG. 4 is an enlarged cross-sectional view showing a vicinity of a boss before a case member is mounted on a base member in the antenna apparatus of the first embodiment;

FIG. 5 is an enlarged cross-sectional view showing the vicinity of the boss after the case member is mounted on the base member in the antenna apparatus of the first embodiment;

FIGS. 6A and 6B are enlarged cross-sectional views showing a structure of a pad member in the vicinity of the boss in the antenna apparatus of the first embodiment;

FIGS. 7A, 7B and 7C show a structure of a groove provided in the pad member of the antenna apparatus of the first embodiment;

FIGS. 8A and 8B are enlarged cross-sectional views showing the structure of the pad member in the vicinity of the boss in the antenna apparatus according to a second embodiment;

FIGS. 9A and 9B are enlarged cross-sectional views showing the structure of the pad member in the vicinity of the boss in the antenna apparatus according to a third embodiment;

FIGS. 10A to 10E are enlarged cross-sectional views showing the vicinity of the boss in the antenna apparatus of a fourth embodiment; and

FIGS. 11A and 11B are enlarged plan views showing a vicinity of an opening of the pad member in the antenna apparatus of a fifth embodiment.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

A system in which a base member and a cover member are fixed with a screw is adopted in an automobile antenna described in JP-A-2005-102031. Specifically, the cover member is provided with a boss into which the screw is inserted. The screw is inserted into the boss through a hole provided in the base member. Thus, the base member and the cover member are fixed to each other. At that time, a pad member is sandwiched between the base member and a head of the screw. In this way, an antenna apparatus described in JP-A-2005-102031 restrains moisture and the like from entering from below the base member by interposing the pad member between the base member and the head of the screw.

However, the automobile antenna directly receives vibration of a vehicle, and is often placed in an environment in which the vibration is severe. In the automobile antenna described in JP-A-2005-102031, when the screw is loosened even a little due to the vibration of the vehicle, moisture and the like may enter from a small gap between the head of the screw and the pad member, and enter the inside through the screw. As described above, it is difficult for the automobile antenna described in JP-A-2005-102031 to restrain moisture and the like from entering the inside through the screw.

An object of the present disclosure is to ensure good waterproofness and dustproofness of the antenna apparatus, and specifically to restrain moisture and the like from entering the inside through a fixing tool such as the screw.

According to an embodiment of the present disclosure, an antenna apparatus includes: a base member; a case member fixed to the base member with a fixing tool; and a pad member for covering a peripheral edge of the base member. The case member has a boss into which the fixing tool is inserted. A portion of the pad member is compressed by fixing the boss and the base member with the fixing tool.

In the above antenna apparatus, a step may be provided between an upper surface of the pad member and an upper surface of the base member in a region overlapping the boss in plan view.

In the above antenna apparatus, a thickness of a first portion of the pad member located between the boss and the base member may be thinner than a thickness of a second portion adjacent to the first portion of the pad member.

In the above antenna apparatus, an upper surface of at least one of a first portion of the pad member located between the boss and the base member and a second portion adjacent to the first portion of the pad member may have a groove.

In the above antenna apparatus, the groove may be provided to surround an opening of the pad member in plan view.

In the above antenna apparatus, the groove may have a first side wall closer to the boss and a second side wall facing the first side wall in cross-sectional view. When the boss and the base member are fixed with the fixing tool, the first side wall and the second side wall may be separated from each other.

According to an embodiment of the present disclosure, an antenna apparatus includes: a base member; a case member fixed to the base member with a fixing tool; and a pad member for coveting a peripheral edge of the base member. The case member has a boss fixed with the fixing tool. An upper surface of at least one of a first portion of the pad member located between the boss and the base member and a second portion adjacent to the first portion of the pad member has a groove.

In the above antenna apparatus, the groove may be provided to surround an opening of the pad member in plan view.

In the above antenna apparatus, the groove may have a first side wall closer to the boss and a second side wall facing the first side wall in cross-sectional view and the first side wall and the second side wall may be separated from each other.

In the above antenna apparatus, the fixing tool may be a screw.

According to an embodiment of the present disclosure, an antenna apparatus includes: a base member; a case member fixed to the base member with a fixing tool; and a pad member for coveting a peripheral edge of the base member. The case member has a boss into which the fixing tool is inserted. A portion of the pad member is compressed by fixing the boss and the base member with the fixing tool. A step is provided between an upper surface of the pad member and an upper surface of the base member in a region overlapping the boss in plan view.

According to an embodiment of the present disclosure, good waterproofness and dustproofness of the antenna apparatus can be ensured.

Hereinafter, embodiments of the present disclosure will be described with reference to the drawings. However, aspects of the present disclosure can be implemented in many different aspects. The aspects of the present disclosure should not be interpreted as being limited to description of examples shown below. In the drawings referred to in the following embodiments, the same portions or portions having the same functions are denoted by the same reference numerals, and repeated description thereof may be omitted.

In the present specification, the terms “upper” and “lower” may be used for the convenience of description. When the antenna apparatus is mounted on the vehicle, a direction from the vehicle to the antenna apparatus is referred to as “up”, and the opposite direction is referred to as “down”. Further, the terms “front”, “rear”, “left”, and “right” may be used. A traveling direction of the vehicle is “front”, and the opposite direction is “rear”. Further, a left side in the traveling direction of the vehicle is referred to as “left”, and a right side thereof is referred to as “right”.

### First Embodiment

(Structure of Antenna Apparatus)

An antenna apparatus 10 of a first embodiment will be described. The antenna apparatus 110 is an on-vehicle antenna apparatus mounted on a roof of the vehicle. In the present embodiment, an antenna apparatus of a type having a rod-like antenna element is exemplified as the antenna apparatus 10. However, the embodiment of the present disclosure is not limited to this example, and may be applied to the antenna apparatus of a type called a shark fin antenna. A place on which the antenna apparatus is mounted is not limited to the roof of the vehicle. For example, the antenna apparatus 10 described in the present embodiment can be mounted on a spoiler, a trunk cover, or the like besides the vehicle roof.

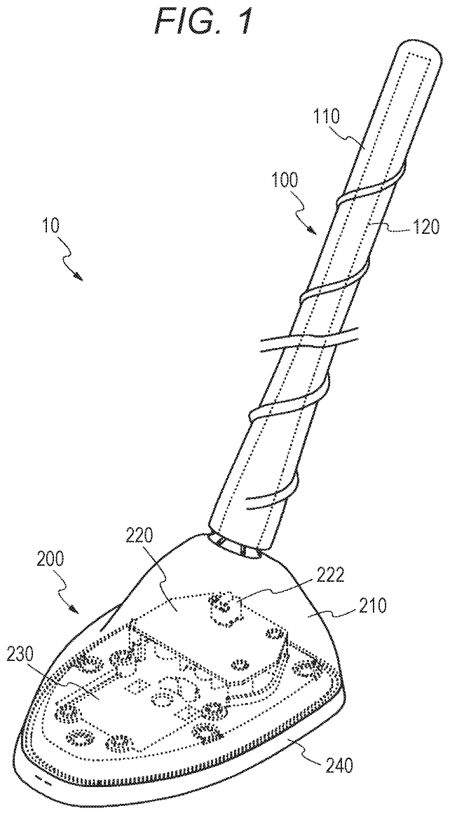

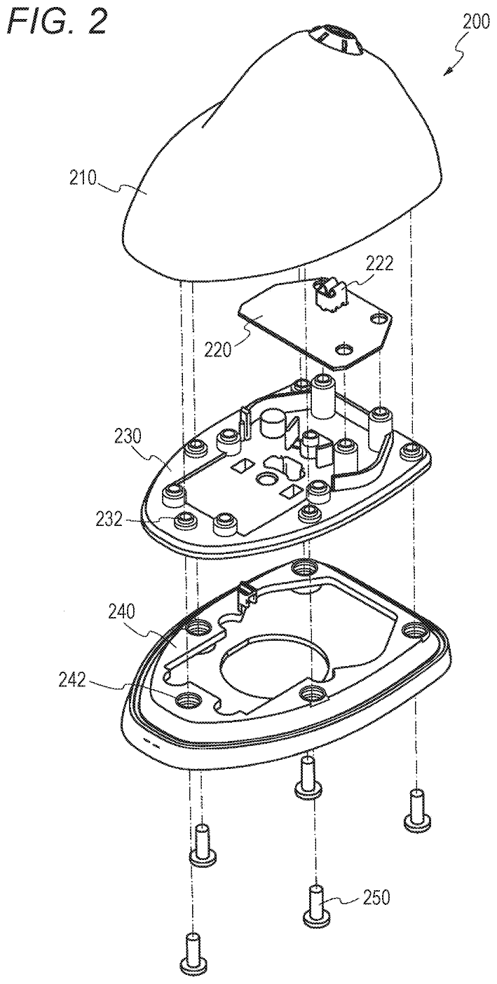

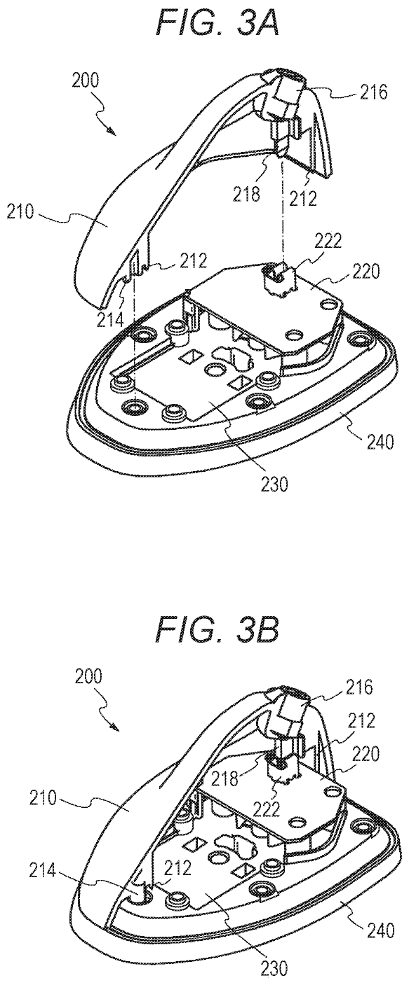

FIG. 1 is a perspective view showing an appearance of the antenna apparatus 10 of the first embodiment. FIG. 2 is an exploded perspective view showing an internal structure of an antenna mounting unit 200 in the antenna apparatus 10 of the first embodiment. FIGS. 3A and 3B are perspective views showing the internal structure of the antenna mounting unit 200 in the antenna apparatus 10 of the first embodiment. Specifically, FIG. 3A shows a state of the antenna mounting unit 200 before mounting a case member 210 on a base member 230. FIG. 3B shows the state of the antenna mounting unit 200 after mounting the case member 210 on the base member 230. However, in FIGS. 3A and 3B, illustration of half of the case member 210 is omitted for the convenience of description.

As shown in FIG. 1, the antenna apparatus 10 includes an antenna mast 100 and the antenna mounting unit 200. In FIG. 1, the internal structure of the antenna mounting unit 200 is indicated by a dotted line. Details of the internal structure of the antenna mounting unit 200 will be described below.

In FIG. 1, the antenna mast 100 is a portion of the antenna apparatus 10 for transmitting and receiving radio waves. The antenna mast 100 has a shaft portion 120 made of a resin member inside a rod-like cover member 110. In FIG. 1, the shaft portion 120 is indicated by a dotted line. A wire-like conductor (not shown) is wound around the shaft portion 120. The conductor constitutes the antenna element for transmitting and receiving radio waves.

The antenna mounting unit 200 is a portion of the antenna apparatus 10 mounted on the roof (not shown) of the vehicle. As shown in FIG. 2, the antenna mounting unit 200 includes the case member 210, a circuit board 220, the base member 230, and a pad member 240. As described bellow, the case member 210 is fixed to the base member 230 with the fixing tool. In the present embodiment, screws 250 are exemplified as the fixing tool. Further, the fixing tool is not limited to this example, and a rivet or a snap fit may be used.

The case member 210 is a member made of, for example, a synthetic resin having a property of transmitting radio waves. The case member 210 has a role of protecting electronic components such as the circuit board 220 disposed inside the antenna mounting unit 200 from moisture and the like outside. As shown in FIGS. 3A and 3B, an inner surface of the case member 210 is provided with a rib 212 and a plurality of bosses 214. As described below, the rib 212 is pressed against the pad member 240 when the case member 210 is mounted on the base member 230. As a result, a waterproof and dustproof structure is formed. The bosses 214 are cylindrical portions for inserting the screws 250. Further, a connection portion 216 is provided on a top portion of the case member 210. The connection portion 216 is a portion on which the antenna mast 100 is mounted. The connection portion 216 is connected to the circuit board 220 through a connection terminal 218.

The circuit board 220 performs processing of signals received by the antenna mast 100 and processing of signals transmitted from the antenna mast 100. The circuit board 220 is provided with, for example, signal processing circuits (not shown) including a filter circuit, an amplifier circuit, and other circuits. The signal processing circuits are electrically connected to a connector 222 provided on the circuit board 220. Thus, the signal processing circuits and the antenna element are electrically connected via the connector 222 and the connection terminal 218.

In a structure exemplified in the present embodiment, the circuit board 220 is disposed inside the antenna mounting unit 200. The circuit board 220 is not limited to this example, and may be disposed outside the antenna mounting unit 200. It is also possible to provide another antenna element such as a planar antenna on the base member 230 instead of or in addition to the circuit board 220. As another antenna element, for example, the antenna for receiving a GNSS signal or the antenna for receiving a cellular signal can be disposed.

The base member 230 is a member made of a metal material. The circuit board 220 is fixed on the base member 230 by the fixing tool (not shown) such as the screw. Thus, the circuit board can be grounded. Although not shown, a bolt portion for mounting the antenna apparatus 10 on the vehicle is provided, the bolt portion projecting downward on a lower surface of the base member 230. The base member 230 is provided with a plurality of screw holes 232 for inserting the screws 250.

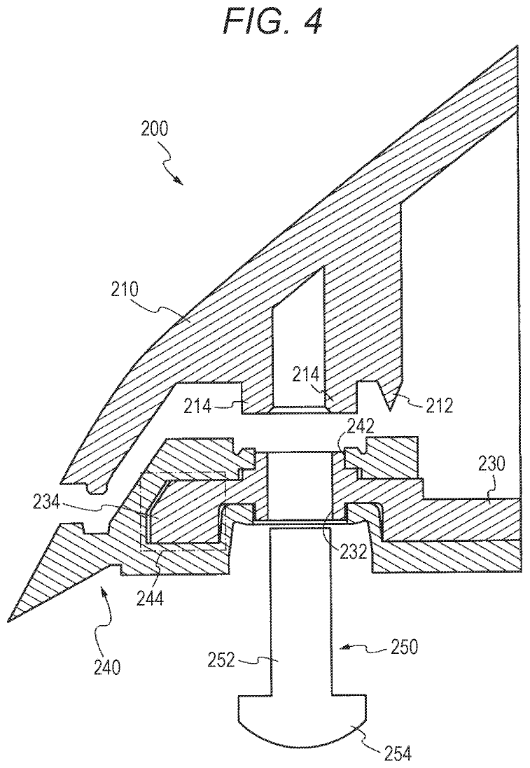

The pad member 240 is, for example, a member made of an elastic member such as rubber and an elastomer. As described below, an outer peripheral portion of the pad member 240 has a structure having a space 244 (see FIG. 4) so as to cover a peripheral edge of the base member 230. An outer edge portion of the pad member 240 located below the base member 230 extends outwardly of the antenna apparatus 10. The outer edge portion is configured to be in close contact with the roof of the vehicle when the antenna apparatus 10 is mounted on the vehicle. The outer edge portion of the pad member 240 in close contact with the roof of the vehicle functions as a protective member for restraining moisture and the like from entering below the base member 230. In addition, the outer edge portion of the pad member 240 can restrain an edge of the case member 210 from damaging the roof. It can also restrain the base member 230 and the like from being visually recognized from the outside.

The pad member 240 is provided with a plurality of openings 242 for inserting the screws 250. A diameter of each of the openings 242 is larger than that of the screw hole 232 of the base member 230. As described below in a state in which the pad member 240 is mounted on the base member 230, the screw hole 232 of the base member 230 falls inside each of the openings 242.

As shown by one-dot chain lines in FIGS. 2 and 3A, the antenna apparatus 10 of the present embodiment having the above structure is assembled so that positions of the bosses 214 of the case member 210, positions of the screw holes 232 of the base member 230, and positions of the openings 242 of the pad member 240 are aligned with each other. Therefore, the case member 210 can be fixed to the base member 230 by inserting the screws 250. Thus, the circuit board 220 is disposed in a space formed by the case member 210 and the base member 230, that is, in the space surrounded by the case member 210 and the base member 230.

At this time, in the antenna apparatus 10 of the present embodiment, the peripheral edge of the base member 230 is covered by the outer peripheral portion of the pad member 240. Therefore, as shown in FIG. 3B, when the case member 210 is mounted on the base member 230, the pad member 240 is in a state of being sandwiched between a portion (specifically, the rib 212 and the boss 214) of the case member 210 and the base member 230. Thus, it is possible to form a sealed space shielded from outside air between the case member 210 and the base member 230.

FIG. 4 is an enlarged cross-sectional view showing a vicinity of the boss 214 before the case member 210 is mounted on the base member 230 in the apparatus 10 of the first embodiment. That is, FIG. 4 corresponds to an enlarged cross-sectional view in the vicinity of the boss 214 in a state shown in FIG. 3A.

As shown in FIG. 4, the pad member 240 has the space 244 for receiving a peripheral edge 234 of the base member 230 in the outer peripheral portion thereof. In the present embodiment, the base member 230 and the pad member 240 are combined by inserting the peripheral edge 234 of the base member 230 into the space 244 of the pad member 240. At this time, the screw hole 232 of the base member 230 is disposed to fall inside the opening 242 of the pad member 240. Thus, the case member 210 is mounted from above the base member 230 and the pad member 240 in a state in which the base member 230 and the pad member 240 are combined. Note that FIG. 4 shows the screw 250 before insertion. The screw 250 is inserted from below into the screw hole 232 of the base member 230. The screw 250 has a threaded portion 252 and a head 254.

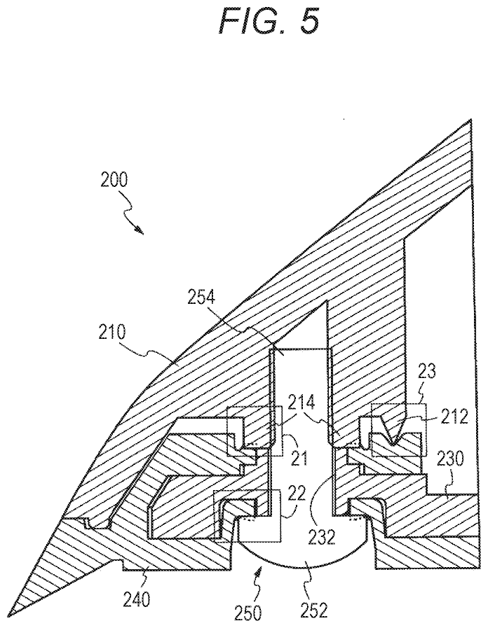

FIG. 5 is an enlarged cross-sectional view showing the vicinity of the boss 214 after the case member 210 is mounted on the base member 230 in the antenna apparatus 10 of the first embodiment. That is, FIG. 5 corresponds to an enlarged cross-sectional view in the vicinity of the boss 214 in a state shown in FIG. 3B.

As shown in FIG. 5, after the pad member 240 is mounted on the base member 230, the screw 250 is inserted into the boss 214 of the case member 210 and the screw hole 232 of the base member 230. By fixing the case member 210 and the base member 230 with the screw 250, a strong pressure is generated between the case member 210 and the base member 230. As a result, the pad member 240 sandwiched between the case member 210 and the base member 230 is compressed with a strong force. Thus, it is possible to obtain a waterproof and dustproof effect by the pad member 240.

In FIG. 5, frame lines 21 to 23 indicate portions in which the waterproof and dustproof effect by the pad member 240 can be obtained. Specifically, in the portion indicated by the frame line 21, the waterproof and dustproof effect is obtained by sandwiching a portion of the pad member 240 between the case member 210 and the base member 230. In the portion indicated by the frame line 22, the waterproof and dustproof effect is obtained by sandwiching a portion of the pad member 240 between the head 254 of the screw 250 and the base member 230. In the portion indicated by the frame line 23, the waterproof and dustproof effect is obtained by pressing the rib 212 of the case member 210 against the pad member 240.

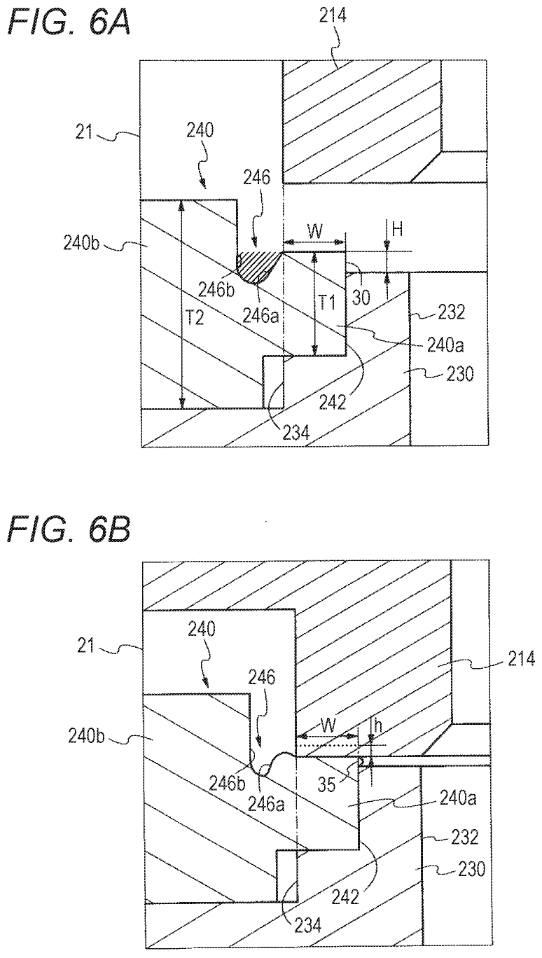

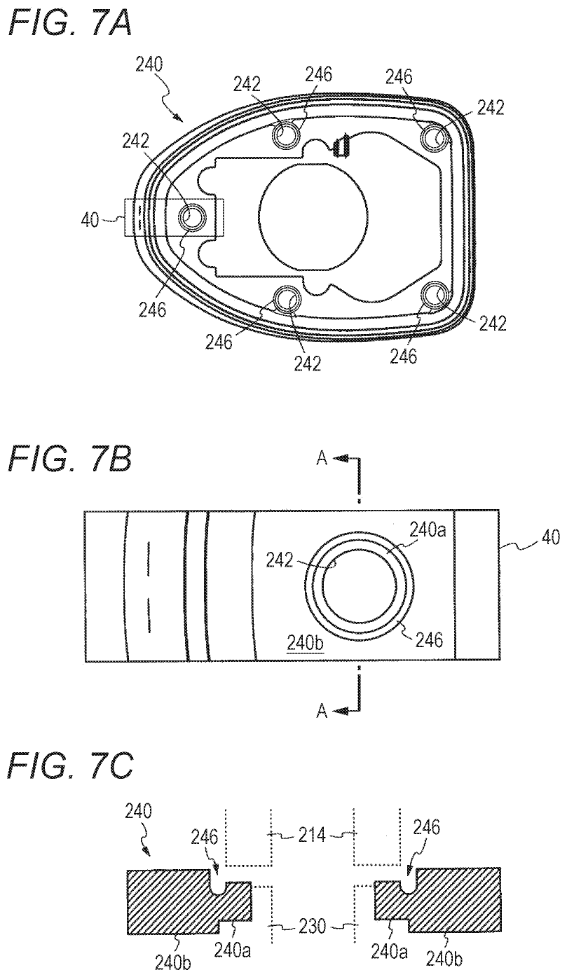

Specifically, in the antenna apparatus 10 of the present embodiment, the portion indicated by the frame line 21 is a structure effective to restrain moisture and dust from entering from the outside through the screw. Here, a detailed structure of the portion indicated by the frame line 21 will be described with reference to FIGS. 6A, 6B, 7A, 7B, and 7C.

FIGS. 6A and 6B are enlarged cross-sectional views showing a structure of the pad member 240 in the vicinity of the boss 214 in the antenna apparatus 10 of the first embodiment. Specifically, FIG. 6A shows a state of the pad member 240 before being compressed by the boss 214 and the base member 230. That is, FIG. 6A corresponds to an enlarged view in the vicinity of the boss 214 in a state shown in FIG. 4. FIG. 6B shows the state of the pad member 240 compressed by the boss 214 and the base member 230 by tightening the screw 250. That is, FIG. 6B corresponds to an enlarged view in the vicinity of the boss 214 in a state shown in FIG. 5. In FIG. 6B, illustration of the screw 250 is omitted for the convenience of description.

As shown in FIGS. 6A and 6B, in the present embodiment, the antenna apparatus 10 has a structure such that a portion (portion around the opening 242 in plan view) of the pad member 240 is sandwiched between the boss 214 and the base member 230. In the present embodiment, a portion of the pad member 240 that is located between the boss 214 and the base member 230 in cross-sectional view is referred to as a “first portion 240a”. Further, a portion of the pad member 240 that is adjacent to the first portion 240a and does not overlap the boss 214 in cross-sectional view is referred to as a “second portion 240b”.

The first portion 240a is a portion disposed to surround the screw hole 232 of the base member 230. In other words, the first portion 240a is a portion of the pad member 240 that surrounds the opening 242 and overlaps the boss 214. In the present embodiment, a thickness of the first portion 240a is assumed to be “T1”.

The second portion 240b is a portion adjacent to the first portion 240a, and is a portion disposed to surround the first portion 240a. That is, it can also be said that the second portion 240b is a portion located around the first portion 240a or a portion located around the boss 214 in plan view. In the present embodiment, the thickness of the second portion 240b is assumed to be “T2”. In the present embodiment, the thickness T1 of the first portion 240a is thinner than the thickness T2 of the second portion 240b. However, the thickness T1 of the first portion 240a and the thickness T2 of the second portion 240b are not limited to this example, and may be equal to each other.

In FIG. 6A, a step 30 with a height H is provided between an upper surface of the first portion 240a and an upper surface of the base member 230 in a region overlapping the boss 214 in plan view. In the present embodiment, by providing the step 30 between the upper surface of the first portion 240a and the upper surface of the base member 230, a structure is obtained in which a portion (the first portion 240a) of the pad member 240 is compressed when the case member 210 and the base member 230 are fixed with the screw 250. That is, as shown in FIG. 6B, the first portion 240a is compressed by applying a strong pressure to the first portion 240a between the boss 214 and the base member 230.

In the case of the present embodiment, even after the first portion 240a is compressed, there may be a step 35 between the upper surface of the first portion 240a and the upper surface of the base member 230 in the region overlapping the boss 214 in plan view. In that case, in FIG. 6B, a height of the step 35 is represented by H-h. In other words, after the first portion 240a is compressed, it can also be said that there is a gap represented by the height (H-h) between the boss 214 and the base member 230. However, in practice, since a crushed portion of the first portion 240a projects into a groove 246 described below, the step 35, that is, the height H-h is small enough to be ignored. As described below, “h” is a displacement amount in a height direction (vertical direction) of the first portion 240a when the first portion 240a is compressed.

As described below with reference to FIGS. 7A to 7C, the step 30 is annularly disposed to surround the screw hole 232 of the base member 230. Therefore, even if moisture or the like enters from the outside through the screw 250, it is possible to restrain moisture or the like from entering the space formed by case member 210 and base member 230 by the waterproof and dustproof effect described with reference to FIGS. 6A and 6B. Thus, according to the present embodiment, it is possible to ensure good waterproofness and dustproofness of the antenna apparatus 10.

By the way, in the present embodiment, the groove 246 is provided on the upper surface of the second portion 240b. Specifically, as shown in FIG. 6A, the groove 246 is provided on the upper surface of the second portion 240b near a boundary with the first portion 240a. The groove 246 is disposed to surround the compressed first portion 240a of the pad member 240 in plan view.

FIGS. 7A to 7C show a structure of the groove 246 provided in the pad member 240 of the antenna apparatus 10 of the first embodiment. Specifically, FIG. 7A shows the pad member 240 and the groove 246 in plan view. FIG. 7B is an enlarged view of a portion indicated by a frame line 40 in FIG. 7A. FIG. 7C is a cross-sectional view of a portion including the opening 242 taken along a one-dot chain line A-A shown in FIG. 7B.

As shown in FIG. 7A, the pad member 240 of the present embodiment is provided with the plurality of openings 242. Each of the plurality of openings 242 is surrounded by the groove 246. That is, as shown in FIG. 7B, the groove 246 is disposed to surround the opening 242 and the first portion 240a of the pad member 240. Note that a portion located outside the groove 246 in the pad member 240 is the second portion 240b. In the cross-sectional view shown in FIG. 7C, the boss 214 and the base member 230 are shown by dotted lines. A positional relationship among the boss 214, the base member 230, and the pad member 240 is as described with reference to FIGS. 6A and 6B.

The groove 246 having the above structure functions as a space for a portion of the first portion 240a deformed by compression to project therein as shown in FIG. 6B. That is, when the portion of the first portion 240a projects due to deformation associated with compression, the groove 246 has a role of ensuring a space for receiving a projecting portion of the first portion 240a. Therefore, in the antenna apparatus 10 of the present embodiment, influence of the deformation of the first portion 240a is absorbed by the groove 246 to be unlikely to extend to the outside (a side opposite to a side where the first portion 240a is located) of the groove 246.

Here, role of the groove 246 will be described. As described above, in the portion indicated by the frame line 23 in FIG. 5, the rib 212 of the case member 210 is pressed against the upper surface of the portion (specifically, the second portion 240b) of the pad member 240. Thus, by pressing the rib 212 against the portion of the pad member 240 in the portion indicated by the frame line 23, the waterproof and dustproof effect by the pad member 240 can be obtained.

At this time, if the groove 246 is not provided, when the first portion 240a is deformed by compression of the base member 230 and the boss 214 by fastening the screw, the influence of the deformation is also easily transmitted to the second portion 240b directly below the rib 212. The influence of the deformation is that, for example, compression of the first portion 240a causes the second portion 240b to be pulled in a compression direction (direction toward the screw). In this case, the second portion 240b may also be deformed along with the deformation of the first portion 240a. As a result, since it is difficult for the rib 212 to press the upper surface of the second portion 240b uniformly, the waterproofness and the dustproofness may be impaired.

However, in the present embodiment, the groove 246 is provided in the pad member 240. Therefore, the influence of the deformation of the first portion 240a is unlikely to extend to the second portion 240b outside the groove 246. That is, the portion of the first portion 240a deformed by compression projects into the groove 246. Therefore, the second portion 240b is hardly affected by the deformation due to the compression of the first portion 240a. Then, the rib 212 contacts the upper surface of the second portion 240b substantially uniformly. Thus, waterproofness and dustproofness can be ensured in the portion indicated by the frame line 23.

In order to cause the portion of the first portion 240a deformed by compression to project into the groove 246, it is desirable to ensure a volume of the groove 246 as large as possible. As shown in FIG. 6A, in the cross-sectional view, the groove 246 has a first side wall 246a closer to the boss 214 and a second side wall 246b facing the first side wall 246a. The groove 246 in the present embodiment desirably has a sufficient volume such that the first side wall 246a and the second side wall 246b are separated from each other even if the first portion 240a is deformed by compression.

For example, as shown in FIGS. 6A and 6B, a width of the first portion 240a in the cross-sectional view is assumed to be “W”. Further, it is assumed that the first portion 240a is compressed by “h” in the height direction. In this case, an area S1 (hereinafter, referred to as a “compressed area S1”) in which the first portion 240a is compressed in the cross-sectional view can be obtained by S1=W×h. Here, an area of a hatched area in the groove 246 in FIG. 6A is defined as a “groove area S2”. It is desirable that the groove area S2 be larger than the compressed area S1. That is, it is desirable that the groove area S2 satisfy at least S2≥S1 (preferably S2≥2×S1). When the groove area S2 satisfies this relationship, it can be said that the groove 246 has a volume sufficient to receive the portion of the first portion 240a projecting by deformation. In this way, by securing the groove area S2 larger than the compressed area S1, the influence of the deformation of the first portion 240a can be appropriately absorbed by the groove 246.

Further, as shown in FIG. 6A, in the present embodiment, a step 234 is provided around the screw hole 232 of the base member 230. The above-mentioned groove 246 is provided not to overlap the step 234. Thus, it is possible to obtain a structure in which the portion of the first portion 240a compressed between the boss 214 and the base member 230 easily projects into the groove 246.

As described above, in the present embodiment, the portion (first portion 240a) of the pad member 240 is compressed by the boss 214 and the base member 230. Thus, it is possible to obtain a structure that restrains moisture and dust from entering through the screw 250. Further, the groove 246 is provided around the first portion 240a in the pad member 240. Thus, it is possible to obtain a structure in which the influence of the deformation of the first portion 240a does not easily extend to the pad member 240 around the first portion 240a. As a result, it is possible to achieve a structure that restrains moisture and the like from entering through the screw 250 without impairing the effect of the waterproof and dustproof structure formed by the rib 212 and the pad member 240.

In the structure exemplified in the present embodiment, the step 30 is provided between the upper surface of the first portion 240a and the upper surface of the base member 230 in the region overlapping the boss 214 in plan view. Further, the groove 246 is provided adjacent to the first portion 240a. However, the structure of the present embodiment is a structure in which the portion (first portion 240a) of the pad member 240 is compressed by the boss 214 and the base member 230. Therefore, in the structure of the present embodiment, even if the groove 246 is not provided, it is possible to obtain the effect of restraining moisture and the like from entering the inside through the screw 250.

### Second Embodiment

In the structure exemplified in the first embodiment, the gap is left between the boss 214 and the base member 230 even after the first portion 240a is compressed (see FIG. 6B). In this regard, the boss 214 and the base member 230 may be in contact with each other after the first portion 240a is compressed. In the present embodiment, portions common to those in the antenna apparatus 10 of the first embodiment are denoted by the same reference numerals, and descriptions thereof may be omitted.

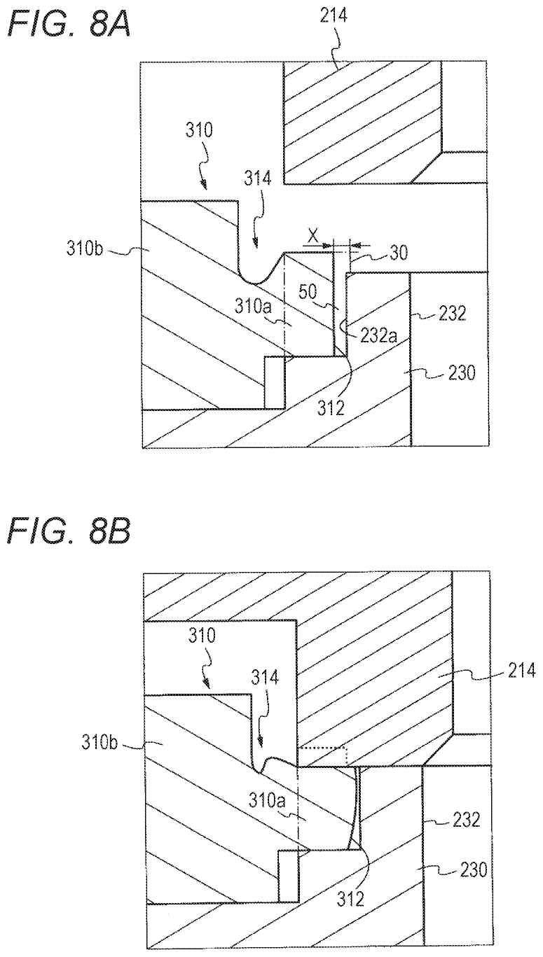

FIGS. 8A and 8B are enlarged cross-sectional views showing a structure of the pad member 310 in the vicinity of the boss 214 in the antenna apparatus 10 according to a second embodiment. Specifically, FIG. 8A shows a state of the pad member 310 before being compressed by the boss 214 and the base member 230. FIG. 8B shows the state of the pad member 310 compressed by the boss 214 and the base member 230.

As shown in FIG. 8A, in the second embodiment, a gap 50 having a width X is provided between an opening 312 of the pad member 310 and a surface 232a of the base member 230 facing the opening 312. Therefore, as shown in FIG. 8B, when the portion (first portion 310a) of the pad member 310 is compressed, the pad member 310 can be compressed until the boss 214 and the base member 230 contact each other. That is, when the first portion 310a of the pad member 310 is compressed, a structure can be obtained in which the surface of the base member 230 facing the boss 214 and the upper surface of the first portion 310a are substantially flush with each other. In this case, the portion deformed by compression in the first portion 310a is received in the groove 314 and the gap 50 to be unlikely to affect the second portion 310b. The width X of the gap 50 may be appropriately determined in consideration of degree of deformation of the first portion 310a.

According to the present embodiment, a portion of the pad member 310 can be compressed until the boss 214 and the base member 230 contact each other. Therefore, it is easy to detect an end point of operation of tightening the screw 250. Further, it is possible to suppress damage of the pad member 310 by excessive tightening of the screw 250, and loosening of tightening by the screw 250 conversely.

### Third Embodiment

In the structure exemplified in the first embodiment, as shown in FIG. 6A, the groove 246 is disposed in the upper surface of a portion close to the first portion 240a in the second portion 240b of the pad member 240 (the upper surface near the boundary with the first portion 240a in the second portion 240b). In this regard, the groove 246 may be disposed on the upper surface of at least one of the first portion 240a and the second portion 240b. In the present embodiment, the portions common to those in the antenna apparatus 10 of the first embodiment are denoted by the same reference numerals, and the descriptions thereof may be omitted.

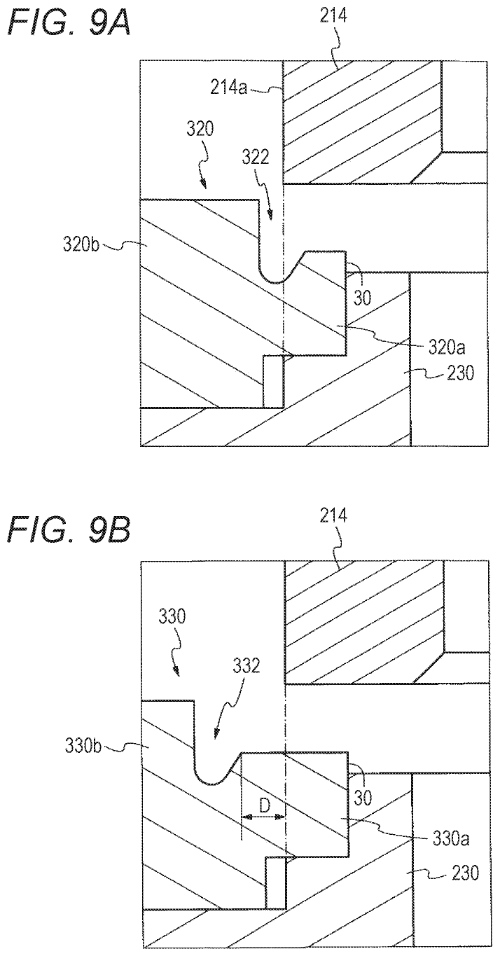

FIGS. 9A and 9B are enlarged cross-sectional views showing the structure of the pad member 320 in the vicinity of the boss 214 in the antenna apparatus 10 according to a third embodiment. Specifically, in an example shown in FIG. 9A, the groove 322 is provided across a first portion 320a and a second portion 320b. In an example shown in FIG. 9B, the groove 332 is provided in a second portion 330b.

In the example shown in FIG. 9A, the pad member 320 includes the first portion 320a overlapping the boss 214 and the second portion 320b adjacent to the first portion 320a. At this time, the groove 322 is disposed at a boundary between the first portion 320a and the second portion 320b in the pad member 320. That is, the groove 322 is located directly below an outer side wall 214a of the boss portion 214.

In the example shown in FIG. 9B, the pad member 330 includes a first portion 330a overlapping the boss portion 214 and the second portion 330b adjacent to the first portion 330a. At this time, the groove 332 is disposed on the upper surface of the second portion 330b at a distance D from the first portion 320a. The distance D is desirably as short as possible so as to absorb the influence of the deformation of the first portion 330a. Further, the distance D is also desirably short in order to miniaturize the antenna apparatus 10.

### Fourth Embodiment

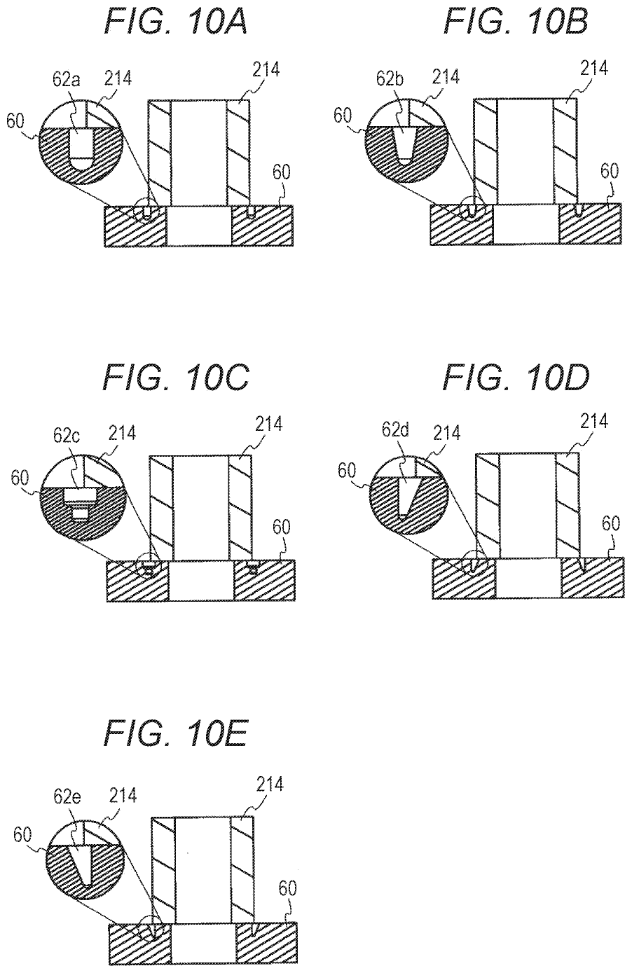

In the present embodiment, a modification of a cross-sectional shape of the groove provided in the pad member will be described with reference to FIGS. 10A to 10E. In FIGS. 10A to 10E, since the structure other than the pad member and the groove is the same as that in the first embodiment, a detailed description thereof will be omitted.

FIGS. 10A to 10E are enlarged cross-sectional views showing the vicinity of the boss 214 in the antenna apparatus 10 of a fourth embodiment. Specifically, in examples shown in FIGS. 10A to 10E, cross-sectional shapes of the grooves disposed in the pad member 60 are different from each other.

In the example shown in FIG. 10A, a groove 62a is disposed in the pad member 60. The groove 62a has a curved bottom and has a shape such that its width is substantially the same up to the bottom. Also, in the present embodiment, as in the first embodiment, the groove 62a is annularly disposed along the side wall of the boss 214 in plan view. The same applies to the grooves 62b to 62e described below in this regard.

In the example shown in FIG. 10B, the groove 62b is disposed in the pad member 60. The groove 62b has a curved bottom and has a shape such that its width is gradually reduced toward the bottom.

In the example shown in FIG. 10C, the groove 62c is disposed in the pad member 60. The groove 62c has a shape in which its diameter is reduced stepwise toward the bottom. In the example shown in FIG. 10C, the groove 62c has two different diameters. The grooves 62c may have three or more different diameters.

In the example shown in FIG. 10D, the groove 62d is disposed in the pad member 60. The groove 62d has a curved bottom and has a shape such that its width is gradually reduced toward the bottom. The groove 62d is different from the groove 62bshown in FIG. 10B in the following points. That is, an angle between a side wall on a side (an inner side) closer to the boss 214 in the groove 62d and the upper surface of the pad member 60 is smaller than that between a side wall on a side (an outer side) farther from the boss 214 in the groove 62d and the upper surface of the pad member 60. That is, the side wall on the side (inner side) closer to the boss 214 in the groove 62d is oblique to the upper surface of the pad member 60. On the other hand, the side wall on the side (outer side) farther from the boss 214 in the groove 62d is substantially perpendicular to the upper surface of the pad member 60.

In the example shown in FIG. 10E, the groove 62e is disposed in the pad member 60. The groove 62e has a curved bottom and has a shape such that its width is gradually reduced toward the bottom. The groove 62e is different from the groove 62d shown in FIG. 10D in the following points. That is, an angle between the side wall on the side (inner side) closer to the boss 214 in the groove 62e and the upper surface of the pad member 60 is larger than that between the side wall on the side (outer side) farther from the boss 214 in the groove 62e and the upper surface of the pad member 60. That is, the side wall on the side (outer side) farther from the boss 214 in the groove 62e is oblique to the upper surface of the pad member 60. On the other hand, the side wall on the side (inner side) closer to the boss 214 in the groove 62e is substantially perpendicular to the upper surface of the pad member 60.

Each of the grooves 62a to 62e shown in FIGS. 10A to 10E described above as a function of absorbing the influence of the deformation of the pad member 60, similarly to the groove 246 shown in the first embodiment. That is, each of the grooves 62a to 62e has an effect that the influence of the deformation by the compression is unlikely to extend to a portion of the pad member 60 outside each of the grooves 62a to 62e when a portion (portion overlapping the boss 214) of the pad member 60 is compressed by the boss 214 and the base member 230.

### Fifth Embodiment

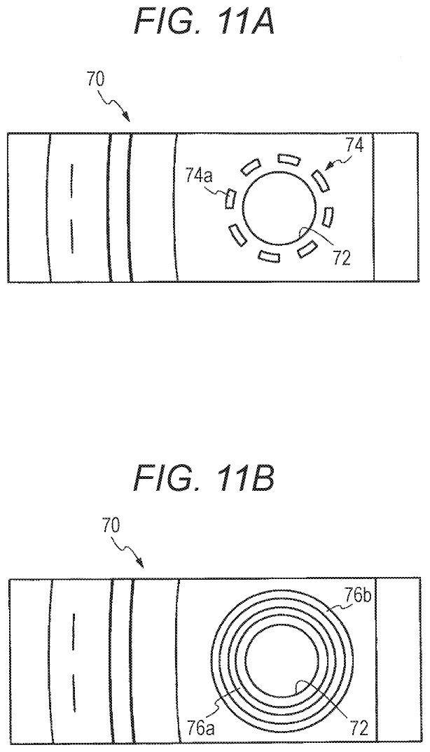

In the present embodiment, a modification of a planar shape of the groove provided in the pad member will be described with reference to FIGS. 11A and 11B. In FIGS. 11A and 11B, since the structure other than the pad member and the groove is the same as that in the first embodiment, the detailed description thereof will be omitted.

FIGS. 11A and 11B are enlarged plan views showing a vicinity of an opening 72 of the pad member 70 in the antenna apparatus 10 of a fifth embodiment. Specifically, in examples shown in FIGS. 11A and 11B, planar shapes of the grooves disposed in the pad member 70 are different from each other.

In the example shown in FIG. 11A, a groove 74 is disposed in the pad member 70 so as to surround the opening 72. The groove 74 is configured by arranging a plurality of grooves 74a around the opening 72 at intervals.

In the example shown in FIG. 11B, a groove 76a and a groove 76b are arranged in the pad member 70 so as to surround the opening 72. The groove 76a and the groove 76b are both annular grooves. At this time, the groove 76b is disposed outside the groove 76a (on a side farther from the opening 72). That is, the annular groove 76a and the annular groove 76b are arranged concentrically with the opening 72. According to the example shown in FIG. 11B, it is possible to obtain a structure that is less susceptible to the influence of the deformation of the pad member 70 as compared to a structure in which one annular groove is provided as in the first embodiment.

In the example shown in FIG. 11B, the groove 76a and the groove 76b are annular grooves. In this regard, at least one of the grooves 76a and 76b may be configured by arranging the plurality of grooves at intervals around the opening 72 as shown in FIG. 11A.

The embodiments of the present disclosure have been described above with reference to the drawings. However, technology of the present disclosure is not limited to the above embodiments. The above embodiments can be modified as appropriate without departing from the scope and spirit of the technology of the present disclosure. Further, the embodiments and modifications described above can be combined with one another, unless there is a particular technical contradiction.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. An antenna apparatus comprising:
a base member;
a case member fixed to the base member with a fixing tool; and
a pad member for covering a peripheral edge of the base member, wherein
the case member has a boss into which the fixing tool is inserted, and wherein
a portion of the pad member is compressed by fixing the boss and the base member with the fixing tool.

2. The antenna apparatus according to claim 1, wherein a step is provided between an upper surface of the pad member and an upper surface of the base member in a region overlapping the boss in plan view.

3. The antenna apparatus according to claim 1, wherein a thickness of a first portion of the pad member located between the boss and the base member is thinner than a thickness of a second portion adjacent to the first portion of the pad member.

4. The antenna apparatus according to claim 1, wherein an upper surface of at least one of a first portion of the pad member located between the boss and the base member and a second portion adjacent to the first portion of the pad member has a groove.

5. The antenna apparatus according to claim 4, wherein the groove is provided to surround an opening of the pad member in plan view.

6. The antenna apparatus according to claim 4, wherein
the groove has a first side wall closer to the boss and a second side wall facing the first side wall in cross-sectional view, and wherein
when the boss and the base member are fixed with the fixing tool, the first side wall and the second side wall are separated from each other.

7. An antenna apparatus comprising:
a base member;
a case member fixed to the base member with a fixing tool; and
a pad member for covering a peripheral edge of the base member, wherein
the case member has a boss fixed with the fixing tool, and wherein
an upper surface of at least one of a first portion of the pad member located between the boss and the base member and a second portion adjacent to the first portion of the pad member has a groove.

8. The antenna apparatus according to claim 7, wherein the groove is provided to surround an opening of the pad member in plan view.

9. The antenna apparatus according to claim 7, wherein
the groove has a first side wall closer to the boss and a second side wall facing the first side wall in cross-sectional view, and wherein
the first side wall and the second side wall are separated from each other.

10. The antenna apparatus according to claim 1, wherein the fixing tool is a screw.
